(19) United States
(12) Patent Application Publication
(10) Pub. No.: US 2026/0057754 A1
(43) Pub. Date: Feb. 26, 2026

(54) TARGET OBJECT MANAGEMENT SYSTEM

(71) Applicant: TAISHO SKY BUILDING, INC., Tokyo (JP)

(72) Inventor: Kazuharu Ishida, Tokyo (JP)

(21) Appl. No.: 19/378,322

(22) Filed: Nov. 3, 2025

Related U.S. Application Data
(63) Continuation of application No. PCT/JP2023/017061, filed on May 1, 2023.

(51) Int. Cl. G08B 13/24; G06F 16/3329; G06T 7/70

(52) U.S. Cl. CPC G08B 13/2462; G06F 16/33295; G06T 7/70

(57) ABSTRACT

A target object management system includes a management server that manages a target object. The management server includes a situation acquisition unit, and the situation acquisition unit includes a use confirmation unit that acquires a position of a user. The situation acquisition unit acquires information on whether or not the position of the user is within a predetermined area, as a situation of the user. If the situation acquisition unit acquires information that the position of the user is within the predetermined area, the management server notifies the user of information on the target object via a terminal device, based on target object information stored in a storage unit.

### RELATED APPLICATIONS

The present application is a continuation of International Patent Application No. PCT/JP2023/017061, filed May 1, 2023, which is hereby incorporated by reference in its entirety.

### TECHNICAL FIELD

This disclosure relates to a target object management system.

### BACKGROUND

Conventional systems for renting rooms of a building (e.g., a vacant conference room in an office, a hotel, or the like) to users typically includes a management server open to a communication network such as the Internet, and a plurality of reservation servers in which information on the conference room is stored. In such systems, users can typically reserve a desired conference room by accessing the conference room information in a reservation server via the management server. Furthermore, such systems may also have a billing function, and may be configured in such a manner that the rental fee can be paid online.

Incidentally, conventional automated conversation systems that automatically respond to human inquiries through chatbots that use artificial intelligence (AI) technology have attracted attention in recent years. Such chatbots that use AI technology are designed to be capable of appropriately responding to human inquiries by causing AI to learn past questions and answers based on a technology such as deep learning.

However, such chatbots that use AI technology typically respond with uniform answers based on a learning result based on past questions and answers, regardless of the current situations of questioners. Therefore, for example, a uniform answer may be given to a question about a conference room being a reserved target object despite which conference room the user has reserved. Accordingly, there is a problem with decreasing user convenience.

### SUMMARY

An object of the present disclosure is to provide a target object management system that can improve user convenience. A target object management system of the present disclosure is a target object management system including: a management server configured to manage a target object; and an information processing means connected to the management server via a communication line and configured to process information and output the information to a user of the target object, in which the management server includes a storage unit configured to store target object information on the target object; a user position acquisition unit configured to acquire a position of the user; and a situation acquisition unit configured to acquire information on whether or not the position of the user acquired by the user position acquisition unit is within a predetermined area, as a situation of the user, and upon the situation acquisition unit acquiring information that the position of the user is within the predetermined area, the management server notifies the user of information on the target object via the information processing means based on the target object information stored in the storage unit.

According to such a configuration, when the situation acquisition unit acquires the information that the position of the user is within the predetermined area, the management server notifies the user of the information on the target object via the information processing means based on the target object information stored in the storage unit. Therefore, the user can receive the information on the target object via the information processing means by entering the predetermined area. Therefore, the target object management system can notify the information processing means of appropriate information on the target object in accordance with the situation of the user, and can improve user convenience.

In the present disclosure, it is preferable that the management server include a question receiving unit configured to receive a user's question about the target object being an inquiry response target via the information processing means; an answer generation unit configured to, upon the question receiving unit receiving the user's question, generate an answer to the user's question; and an answer transmission unit configured to transmit the answer generated by the answer generation unit to the information processing means.

According to such a configuration, when receiving the user's question about the target object being the inquiry response target via the information processing means, the management server causes the answer generation unit to generate an answer to the user's question, and causes the answer transmission unit to transmit, to the information processing means, the answer being information on the target object generated by the answer generation unit. Therefore, the answer generation unit can appropriately generate an answer to the user's question in accordance with the situation of the user, and the answer transmission unit can notify the user of the answer by transmitting the answer to the information processing means. Therefore, the target object management system can transmit an appropriate answer to the user's question in accordance with the situation of the user to the information processing means, and can improve user convenience.

In the present disclosure, it is preferable that the management server include a target object position acquisition unit configured to, upon the question receiving unit receiving the user's question, acquire a position of the target object associated with the question received by the question receiving unit, and the answer generation unit change the answer to the user's question based on a distance between the position of the user acquired by the user position acquisition unit and the position of the target object acquired by the target object position acquisition unit.

According to such a configuration, the answer generation unit changes the answer to the user's question based on the distance between the position of the user acquired by the user position acquisition unit and the position of the target object acquired by the target object position acquisition unit. Therefore, for example, it is possible to generate, for example, a description of the target object, as the answer, when the positions of the user and the target object are close to each other as in a state where the user is holding the target object in his/her hand, and to generate, for example, the location of the target object as the answer when the positions of the user and the target object are distant from each other as in a state where the user is looking for the target object. Therefore, the target object management system can transmit a more appropriate answer to the user's question in accordance with the situation of the user to the information processing means, and can improve user convenience.

In the present disclosure, it is preferable that the answer generation unit acquire related information related to the target object associated with the user's question received by the question receiving unit from outside of the management server via the communication line, and generate an answer to the user's question based on the related information.

According to such a configuration, the answer generation unit acquires the related information related to the target object associated with the user's question received by the question receiving unit from the outside of the management server via the communication line, and generates an answer to the user's question based on the related information. Therefore, it is possible to notify the user of not only information based on the target object information stored in the storage unit but also information based on the related information acquired from the outside of the management server via the communication line. Therefore, the target object management system can transmit a more appropriate answer to the user's question in accordance with the situation of the user to the information processing means, and it is possible to further improve user convenience.

In the present disclosure, it is preferable that the management server include a command receiving unit configured to receive a user's command via the information processing means; and an operation execution unit configured to, upon the command receiving unit receiving the user's command, execute an operation in response to the user's command.

According to such a configuration, when the command receiving unit receives the user's command, the management server causes the operation execution unit to execute an operation in response to the user's command. Therefore, the user can cause the management server to execute a desired operation by transmitting a command to the management server.

In the present disclosure, it is preferable that the operation execution unit cause the target object to execute a predetermined operation based on the user's command received by the command receiving unit.

According to such a configuration, the operation execution unit causes the target object to execute a predetermined operation based on the user's command received by the command receiving unit. Therefore, the user can transmit a command to cause the target object to produce a sound and can confirm the position of the target object, for example, when looking for the target object within a predetermined area. Therefore, the management server can improve user convenience.

In the present disclosure, it is preferable that the target object management system include a facility as the target object connected to the management server and the information processing means via the communication line, the facility include a lock device that locks and unlocks the facility, and the user position acquisition unit acquire a position of the facility as the position of the user upon the lock device of the facility being unlocked properly.

According to such a configuration, when the lock device of the facility has been unlocked properly, the user position acquisition unit acquires the position of the facility as the position of the user. Therefore, it is possible to easily identify the position of the user without providing a new device or function to acquire the position of the user.

In the present disclosure, it is preferable that the management server include a mobile object position acquisition unit configured to acquire a position of a mobile object as a target object installed in the facility, and the answer generation unit generate an answer about the position of the mobile object acquired by the mobile object position acquisition unit.

According to such a configuration, the answer generation unit generates an answer about the position of the mobile object acquired by the mobile object position acquisition unit. Therefore, the user can easily grasp the position of the mobile object installed in the facility.

In the present disclosure, it is preferable that the management server include a device operating unit configured to operate a device as the target object installed in the facility, and the answer generation unit generate an answer about the device operated by the device operating unit.

According to such a configuration, the management server includes the device operating unit configured to operate the device installed in the facility, and the answer generation unit generates an answer about the device operated by the device operating unit. Therefore, it is possible to appropriately answer to a question about the operation of the device installed in the facility, for example, by actually operating the device.

In the present disclosure, it is preferable that the management server include an operating state acquisition unit configured to acquire an operating state of a device as the target object installed in the facility, and the answer generation unit generate an answer about the operating state of the device acquired by the operating state acquisition unit.

According to such a configuration, the management server includes the operating state acquisition unit configured to acquire the operating state of the device installed in the facility, and the answer generation unit generates an answer about the operating state of the device acquired by the operating state acquisition unit. Therefore, it is possible to appropriately answer, for example, a question about a malfunction in the device installed in the facility.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a schematic configuration diagram of a target object management system according to an embodiment of the present disclosure.

FIG. 2 is a functional block diagram illustrating a schematic configuration of the target object management system.

FIG. 3 is a diagram illustrating a flowchart illustrating the operation of the target object management system.

FIG. 4 is a diagram illustrating a touchscreen of a terminal device in a case where a question receiving unit receives a user's question about the position of a mobile object.

FIG. 5 is a diagram illustrating the touchscreen of the terminal device in a case where the question receiving unit receives a user's question about the operation of a device.

FIG. 6 is a diagram illustrating the touchscreen of the terminal device in a case where the question receiving unit receives a user's question about the operating state.

FIG. 7 is a diagram illustrating a state in which the user is being prompted to select one of a plurality of reserved rooms.

FIG. 8 is a diagram illustrating a state after one of the plurality of reserved rooms is selected.

### DETAILED DESCRIPTION

Hereinafter, implementations of the present disclosure will be described with reference to the drawings.

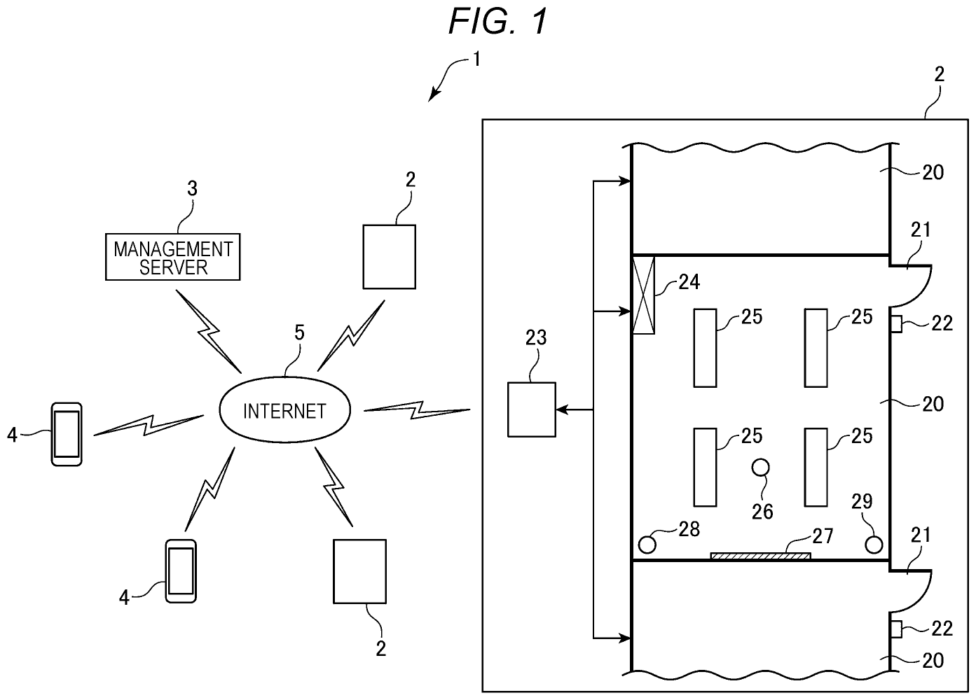

FIG. 1 is a schematic configuration diagram of a target object management system according to an embodiment of the present disclosure.

As illustrated in FIG. 1, a target object management system 1 includes a building 2 having a plurality of rooms 20 (rental spaces) as hourly rental facilities (target objects), a management server 3 that manages the building 2, and a terminal device 4, such as a mobile phone, a smartphone, or a personal computer, that is possessed by a user who wants to use the building 2. The terminal device 4 functions as an information processing means that processes information and outputs the information to the user of an hourly rental facility. The building 2, the management server 3, and the terminal device 4 are connected via an Internet 5, which is a public network as a communication line, in such a manner as to communicate with each other.

Each of the rooms 20 includes an entrance 21 and a lock device 22 for locking and unlocking the entrance 21. The lock device 22 is configured in such a manner as to be capable of being unlocked with an unlock key issued from the management server 3 to the user's terminal device 4, for example, a personal identification number, or an optical code such as a barcode or a QR code (registered trademark). The unlock key is changed randomly for each use, and a user who has made a reservation for a particular time can unlock the lock device 22 with a unique unlock key.

Note that in the embodiment, the unlock key adopts, for example, a personal identification number, or an optical code such as a barcode or a QR code (registered trademark). However, biometric recognition such as facial recognition, fingerprint recognition, or retina recognition may be adopted. Anything that can unlock the lock device 22 is acceptable.

The each of the rooms 20 includes a communication terminal device 23, such as a modem or router, that is connected via a local area network (LAN), and devices 24 to 29 connected to the Internet 5 via the communication terminal device 23. In other words, the devices 24 to 29 are connected to the management server 3 via the Internet 5.

The devices 24 to 29 are what are called Internet of Things (IoT) devices, and can transmit and receive various types of information to and from external devices including the management server 3 by being connected to the Internet 5. Therefore, the management server 3 can control the operation of the devices 24 to 29 by transmitting control commands to the devices 24 to 29, and can receive information transmitted from the devices 24 to 29.

Specifically, the device 24 is an air conditioner 24 installed on a wall surface of the room 20, the device 25 is a plurality of lighting devices 25 installed on the ceiling of the room 20, the device 26 is a projector 26 installed on the floor surface of the room 20, and the device 27 is a screen 27 installed on a wall surface of the room 20. Moreover, the device 28 is an air conditioner remote control 28 for operating the air conditioner 24, and the device 29 is a video remote control 29 for operating the projector 26 and the screen 27.

Note that the devices may be IoT devices of types different from the devices 24 to 29, and the each of the rooms 20 may include other devices, for example, furniture such as a desk and chair, a multifunction machine, a whiteboard, and a liquid crystal display, in addition to the IoT devices such as the devices 24 to 29.

A user can access the management server 3 via the Internet 5 by use of the terminal device 4, look for a room 20 that the user wants to use, designate a date and time for use (use start time and use end time), and make a reservation for the room 20.

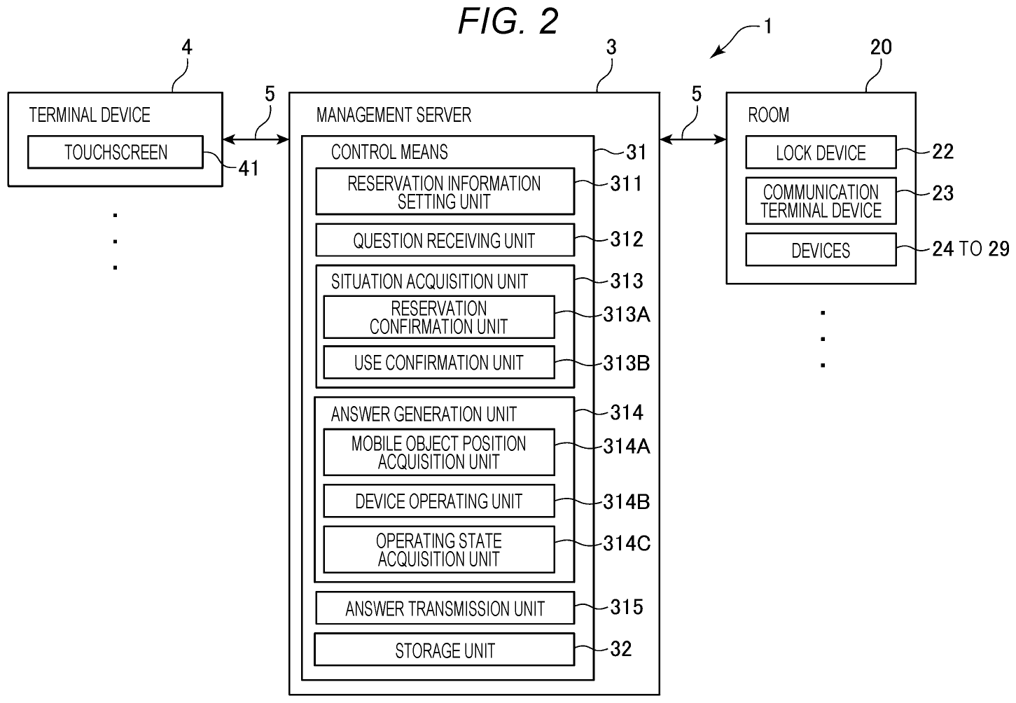

FIG. 2 is a functional block diagram illustrating a schematic configuration of the target object management system.

As illustrated in FIG. 2, the terminal device 4 includes a touchscreen 41. The touchscreen 41 accepts the input of information in accordance with the user's action and provides information as an image to the user.

The management server 3 includes a control means 31. The control means 31 is configured of, for example, a central processing unit (CPU) and memory, and executes information processing in accordance with a predetermined program stored in the memory. The control means 31 includes a reservation information setting unit 311, a question receiving unit 312, a situation acquisition unit 313, an answer generation unit 314, an answer transmission unit 315, and a storage unit 32.

Note that the storage unit 32 is configured of the memory of the control means 31, but may be configured of, for example, a hard disk drive (HDD) or a network attached storage (NAS), or may be configured of a cloud service.

Moreover, the functions of the control means 31 are executed in accordance with programs stored in the storage unit 32. However, the functions may be configured by independent devices, respectively, or may be configured by cloud computing.

Here, the storage unit 32 prestores target object information on the room 20. Specifically, the storage unit 32 prestores the target object information on the room 20, such as the location of the room 20, the positions of the devices 24 to 29 installed in the room 20, the specifications of the devices 24 to 29, use instructions for the devices 24 to 29, and the position of a switch of the lighting devices 25.

The reservation information setting unit 311 accepts a reservation for the room 20 via the terminal device 4 to store and set, in the storage unit 32, reservation information on the user of and the date and time for use (the use start time and the use end time) of the room 20.

The question receiving unit 312 receives a user's question about the room 20 via the terminal device 4.

The situation acquisition unit 313 includes a reservation confirmation unit 313A and a use confirmation unit 313B.

The reservation confirmation unit 313A confirms whether or not the user has reserved the room 20, based on the user associated with the question received by the question receiving unit 312 and the reservation information stored in the storage unit 32.

Specifically, based on the user associated with the question received by the question receiving unit 312 and the reservation information stored in the storage unit 32, the reservation confirmation unit 313A confirms that the user has reserved the room 20 when the user associated with the question is set in the reservation information, and confirms that the user has not reserved the room 20 when the user associated with the question is not set in the reservation information.

When the reservation confirmation unit 313A confirms that the user has reserved the room 20, the use confirmation unit 313B confirms whether or not the user is using the room 20.

Specifically, the use confirmation unit 313B acquires the position of the user associated with the question received by the question receiving unit 312, and acquires information on whether or not the user is using the room 20, as the situation of the user, based on the position of the user and the position of the reserved room 20. For example, the use confirmation unit 313B can be configured in such a manner as to acquire information that the user is using the room 20, as the situation of the user, when the position of the user is in or near the room 20, and to acquire information that the user is not using the room 20, as the situation of the user, when the position of the user is not in or near the room 20. In other words, the use confirmation unit 313B acquires information on whether or not the position of the user associated with the question received by the question receiving unit 312 is within a predetermined area, as the situation of the user. According to such a configuration, the use confirmation unit 313B also functions as a user position acquisition unit that acquires the position of the user.

Here, when the lock device 22 of the room 20 is unlocked properly, the use confirmation unit 313B may acquire the position of the room 20 as the position of the user, or may acquire the position of the user by the user preinstalling an application in the terminal device 4 and preregistering to become a member in the application, and then using, for example, information on the position of the terminal device 4.

In a case where the use confirmation unit 313B is configured in such a manner as to acquire the position of the room 20 as the position of the user when the lock device 22 of the room 20 is unlocked properly, it is possible to easily identify the position of the user without providing a new device or function to acquire the position of the user.

When the use confirmation unit 313B acquires information that the position of the user is within the predetermined area, the answer generation unit 314 generates an answer to the user's question based on the target object information stored in the storage unit 32. In other words, when the use confirmation unit 313B acquires the information that the position of the user is within the predetermined area, the answer generation unit 314 notifies the user of information on the target object via the terminal device 4, based on the target object information stored in the storage unit 32. Specifically, when the situation acquisition unit 313 confirms that the user has reserved the room 20 and acquires the information that the user is not using the room 20, as the situation of the user, the answer generation unit 314 generates an answer about the reserved room 20. Moreover, when the situation acquisition unit 313 acquires the information that the user is using the room 20 as the situation of the user (when the use confirmation unit 313B acquires the information that the position of the user is within the predetermined area), the answer generation unit 314 generates an answer about the room 20 currently in use.

Note that the answer generation unit 314 notifies the user of the information on the target object via the terminal device 4 based on the target object information stored in the storage unit 32, but may be configured in such a manner as to acquire related information related to the target object associated with the user's question received by the question receiving unit 312 from the outside of the management server 3 via the Internet 5 and generate an answer to the user's question, based on the related information. Here, the related information may be any information as long as it is information related to the target object. For example, when the plurality of rooms 20 as the hourly rental facilities is set as target objects, the related information may be information that changes in real time, such as the temperature and weather of a region where the plurality of rooms 20 is, or may be fixed information such as a park and a restaurant in the vicinity of the location where the plurality of rooms 20 is.

According to such a configuration, the answer generation unit 314 can notify the user of not only information based on the target object information stored in the storage unit 32 but also information based on the related information acquired from the outside of the management server 3 via the Internet 5. Therefore, the target object management system 1 can transmit a more appropriate answer to the user's question in accordance with the situation of the user to the terminal device 4, and can further improve user convenience.

Moreover, the situation acquisition unit 313 is configured in such a manner as to cause the user to select one of the plurality of reserved rooms 20 when confirming that the user has reserved the rooms 20 and acquiring information that the user is not using the room 20, as the situation of the user.

Note that, in the embodiment, it is configured in such a manner as to cause the user to select one room 20 when the information that the user is not using the room 20 is acquired as the situation of the user. However, it may be configured in such a manner as to cause the user to select one room 20 regardless of whether or not the user is using the room 20. In the embodiment, the situation acquisition unit 313 is configured in such a manner as to cause the user to select one of the plurality of reserved rooms 20, but may be configured in such a manner as to cause the user to select a plurality of rooms 20.

Here, the answer generation unit 314 includes a mobile object position acquisition unit 314A, a device operating unit 314B, and an operating state acquisition unit 314C.

The mobile object position acquisition unit 314A acquires the position of a mobile object as a target object installed in the room 20. In the embodiment, the mobile object position acquisition unit 314A acquires the positions of the air conditioner remote control 28 and the video remote control 29, which are mobile objects installed in the room 20.

The answer generation unit 314 then generates an answer about the positions of the mobile objects acquired by the mobile object position acquisition unit 314A.

Here, an electronic tag is integrated in each of the air conditioner remote control 28 and the video remote control 29. The mobile object position acquisition unit 314A is configured in such a manner as to be capable of acquiring the positions of the air conditioner remote control 28 and the video remote control 29 by use of the electronic tags.

Note that the mobile object position acquisition unit may adopt any type of configuration as long as it can acquire the position of a mobile object. For example, the mobile object position acquisition unit may be configured in such a manner as to use beacons instead of electronic tags, or to image the interior of the room 20 with an imaging means and acquire the position of a mobile object by image processing.

Note that in the embodiment, when the question receiving unit 312 receives a user's question, the mobile object position acquisition unit 314A also functions as a target object position acquisition unit that acquires the position of the mobile object, which is a target object associated with the question received by the question receiving unit 312.

In addition, the answer generation unit may be configured in such a manner as to change the answer to the user's question based on a distance between the position of the user acquired by the user position acquisition unit and the position of the target object acquired by the target object position acquisition unit. For example, the answer generation unit may be configured in such a manner as to, when the positions of the user and the target object are close to each other as in a state where the user is holding the target object in his/her hand, generate, for example, a description of the target object as the answer, and may be configured in such a manner as to, when the positions of the user and the target object are distant from each other as in a state where the user is looking for the target object, generate, for example, the location of the target object as the answer.

The device operating unit 314B operates the devices 24 to 29 as target objects installed in the room 20. For example, the device operating unit 314B is configured in such a manner as to be capable of operating the projector 26 to switch it on and off, and causing the projector 26 to project a predetermined video.

The answer generation unit 314 then generates answers about the devices 24 to 29 operated by the device operating unit 314B.

The operating state acquisition unit 314C acquires the operating states of the devices 24 to 29 as the target objects installed in the room 20. The operating state acquisition unit 314C is configured in such a manner as to, for example, when the projector 26 is operated by the device operating unit 314B, be capable of acquiring, as operating states, for example, information on whether or not the projector 26 could be switched on or off properly and whether or not the projector 26 could project the predetermined video.

The answer generation unit 314 then generates answers about the operating states of the devices 24 to 29 acquired by the operating state acquisition unit 314C.

Note that in the embodiment, the answer generation unit 314 includes both the device operating unit 314B and the operating state acquisition unit 314C, but may include only one of the functions.

The answer transmission unit 315 transmits the answers generated by the answer generation unit 314 to the terminal device 4.

Note that as described above, in the embodiment, when the question receiving unit 312 receives the user's question, the use confirmation unit 313B also functions as the target object position acquisition unit that acquires the position of the room 20, which is the target object associated with the question received by the question receiving unit 312.

The situation acquisition unit 313 is configured in such a manner as to, when confirming that the user has reserved the rooms 20 and acquiring the information that the user is not using the room 20, as the situation of the user, cause the user to select one of the plurality of reserved rooms 20. Therefore, the contents of the answers generated by the answer generation unit 314 are different between a case where the user is not using the room 20 (a case where the distance between the user and the target object is long) and a case where the user is using the room 20 (a case where the distance between the user and the target object is short). In other words, the answer generation unit changes the answer to the user's question based on the distance between the position of the user acquired by the user position acquisition unit and the position of the target object acquired by the target object position acquisition unit.

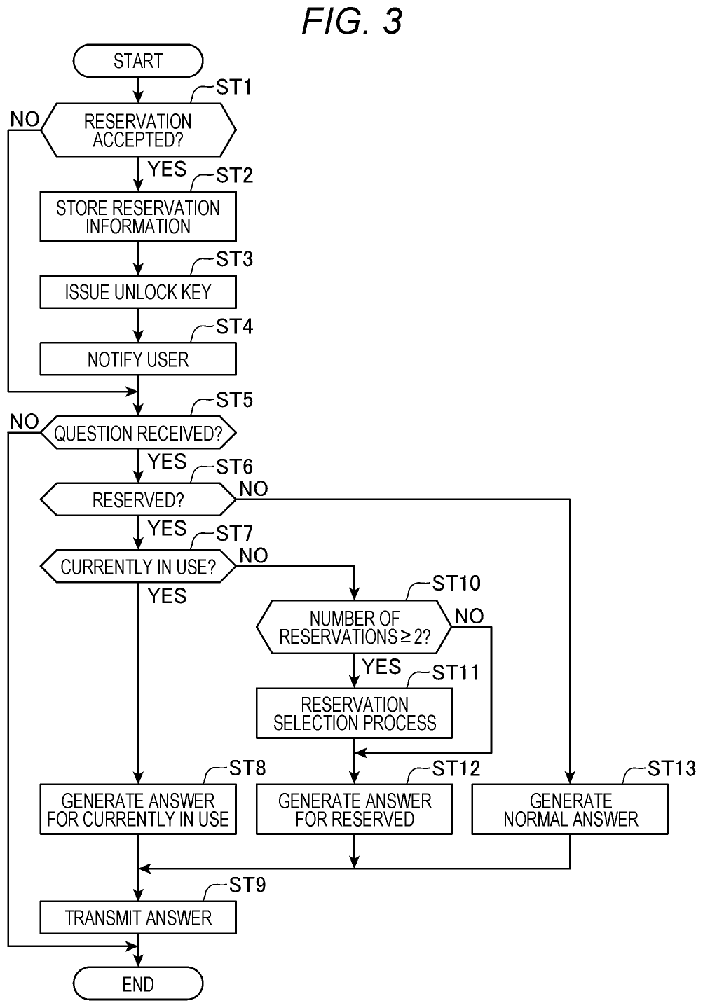

FIG. 3 is a diagram illustrating a flowchart illustrating the operation of the target object management system.

As illustrated in FIG. 3, the control means 31 of the management server 3 repeatedly executes various processes of steps ST1 to ST13 at predetermined time intervals, in accordance with a predetermined program stored in the memory.

As described above, a user of a room 20 can access the management server 3 via the Internet 5 by use of the terminal device 4, look for a room 20 that the user wants to use, designate a time for use, and make a reservation for the room 20.

In step ST1, the control means 31 determines whether or not the reservation for the room 20 has been accepted via the terminal device 4.

When it is determined in step ST1 that the reservation for the room 20 has not been accepted, the control means 31 executes the processes of step ST5 and subsequent steps without executing the processes of step ST2 and subsequent steps.

On the other hand, when it is determined in step ST1 that the reservation for the room 20 has been accepted, the reservation information setting unit 311 stores and sets, in the storage unit 32 in step ST2, reservation information on the user of the room 20 and the date and time for use (the use start time and the use end time) set by the reservation.

After executing the process of step ST2, the control means 31 issues an unlock key that unlocks the lock device 22 of the room 20 to the user based on the reservation information stored in the storage unit 32 in step ST3.

After executing the process of step ST3, the control means 31 notifies the user of the unlock key issued in step ST3 by using, for example, email in step ST4.

After the process of step ST4 is executed, or when it is determined in step ST1 that the reservation for the room 20 has not been accepted, the question receiving unit 312 determines in step ST5 whether or not a user's question about the room 20 has been received via the terminal device 4.

When it is determined in step ST5 that the user's question has not been received, the control means 31 ends the various processes without executing the processes of step ST6 and the subsequent steps.

On the other hand, when it is determined in step ST5 that the user's question has been received, the reservation confirmation unit 313A confirms whether or not the user has reserved the room 20, based on the user associated with the question received by the question receiving unit 312 and the reservation information stored in the storage unit 32, in step ST6.

Specifically, based on the user associated with the question received by the question receiving unit 312 and the reservation information stored in the storage unit 32, the reservation confirmation unit 313A confirms that the user has reserved the room 20 when the user associated with the question is set in the reservation information, and confirms that the user has not reserved the room 20 when the user associated with the question is not set in the reservation information.

When it is determined in step ST6 that the user has reserved the room 20, the control means 31 executes the processes of step ST7 and the subsequent steps.

On the other hand, when it is determined in step ST6 that the user has not reserved the room 20, the control means 31 executes the processes of step ST13 and the subsequent steps.

Firstly, a procedure in a case where it is determined in step ST6 that the user has reserved the room 20 is described.

When it is determined in step ST6 that the user has reserved the room 20, the use confirmation unit 313B acquires information on whether or not the user is using the room 20, as the situation of the user, in step ST7.

Specifically, the use confirmation unit 313B acquires the position of the user associated with the question received by the question receiving unit 312, and acquires information on whether or not the user is using the room 20, as the situation of the user, based on the position of the user and the position of the reserved room 20.

When it is determined in step ST7 that the user is using the room 20, the answer generation unit 314 generates an answer about the room 20 currently in use, in step ST8. The answer transmission unit 315 subsequently transmits the answer generated by the answer generation unit 314 to the terminal device 4, in step ST9. The control means 31 subsequently ends the various processes.

Examples of the answer about the room 20 currently in use are described below.

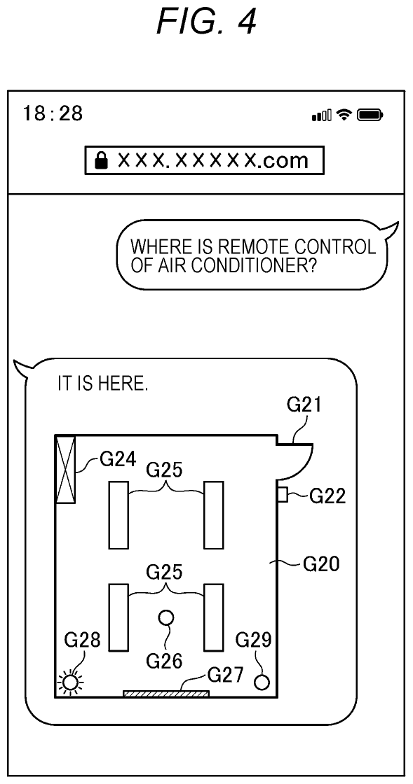

FIG. 4 is a diagram illustrating the touchscreen of the terminal device in a case where the question receiving unit receives a user's question about the position of a mobile object.

For example, as illustrated in FIG. 4, a user operates the touchscreen 41 and thereby can input “Where is the remote control of the air conditioner?” and transmit the question to the management server 3. When the question receiving unit 312 receives such a question from the user, then the mobile object position acquisition unit 314A acquires the position of the air conditioner remote control 28 (a mobile object) installed in the room 20.

The answer generation unit 314 then generates an answer about the position of the air conditioner remote control 28 acquired by the mobile object position acquisition unit 314A, and the answer transmission unit 315 transmits the answer about the position of the air conditioner remote control 28 to the terminal device 4. In the embodiment, the answer generation unit 314 generates an answer in such a manner as to display a map image G20 of the room 20 and device images G24 to G27 of the devices 24 to 27 on the touchscreen 41 of the terminal device 4 and to display a position image G28 indicating the position of the air conditioner remote control 28 in a blinking fashion on the touchscreen 41 of the terminal device 4.

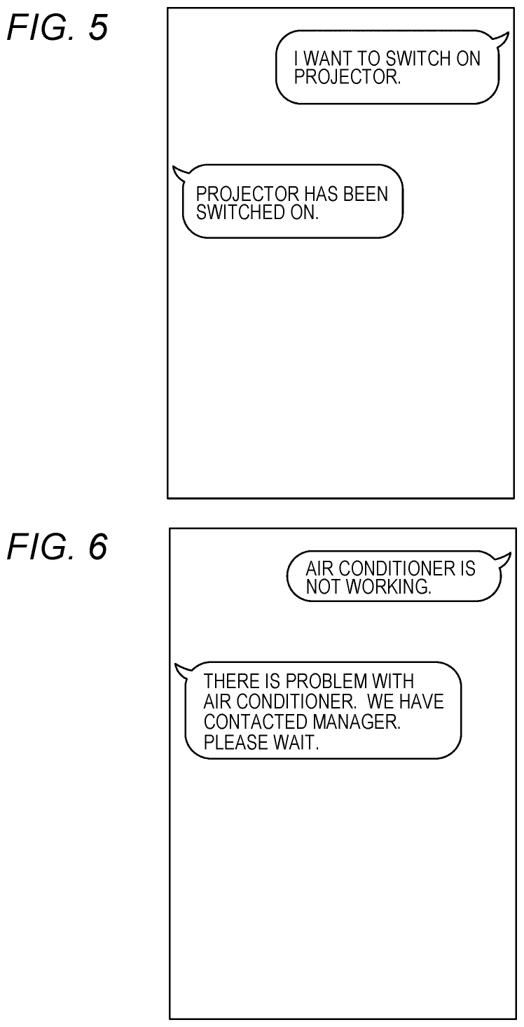

FIG. 5 is a diagram illustrating the touchscreen of the terminal device in a case where the question receiving unit receives a user's question about the operation of a device.

For example, as illustrated in FIG. 5, the user operates the touchscreen 41 and thereby can input “I want to switch on the projector,” and transmit the question to the management server 3. When the question receiving unit 312 receives such a question from the user, then the device operating unit 314B operates the projector 26 installed in the room 20 to switch it on.

The answer generation unit 314 then generates an answer about the projector 26 operated by the device operating unit 314B, and the answer transmission unit 315 transmits the answer about the projector 26 to the terminal device 4. In the embodiment, the answer generation unit 314 generates an answer in such a manner as to display a response: “The projector has been switched on,” as a report to the user, on the touchscreen 41 of the terminal device 4.

FIG. 6 is a diagram illustrating the touchscreen of the terminal device in a case where the question receiving unit receives the user's question about the operating state.

For example, as illustrated in FIG. 6, the user operates the touchscreen 41 and thereby can input “The air conditioner is not working,” and transmit the question to the management server 3. When the question receiving unit 312 receives such a question from the user, then the operating state acquisition unit 314C acquires the operating state of the air conditioner 24 installed in the room 20.

The answer generation unit 314 then generates an answer about the operating state of the air conditioner 24 acquired by the operating state acquisition unit 314C, and the answer transmission unit 315 transmits the answer about the operating state of the air conditioner 24 to the terminal device 4. In the embodiment, the answer generation unit 314 generates answers in such a manner as to display responses: “There is a problem with the air conditioner,” and “We have contacted the manager. Please wait,” as reports to the user, on the touchscreen 41 of the terminal device 4.

Moreover, when it is determined in step ST7 that the user is not using the room 20, the situation acquisition unit 313 determines in step ST10 whether or not the number of reservations for rooms 20 made by the user associated with the question is two or more.

When it is determined in step ST10 that the number of reservations is two or more, the situation acquisition unit 313 causes the user to select one of the plurality of reserved rooms 20 in step ST11.

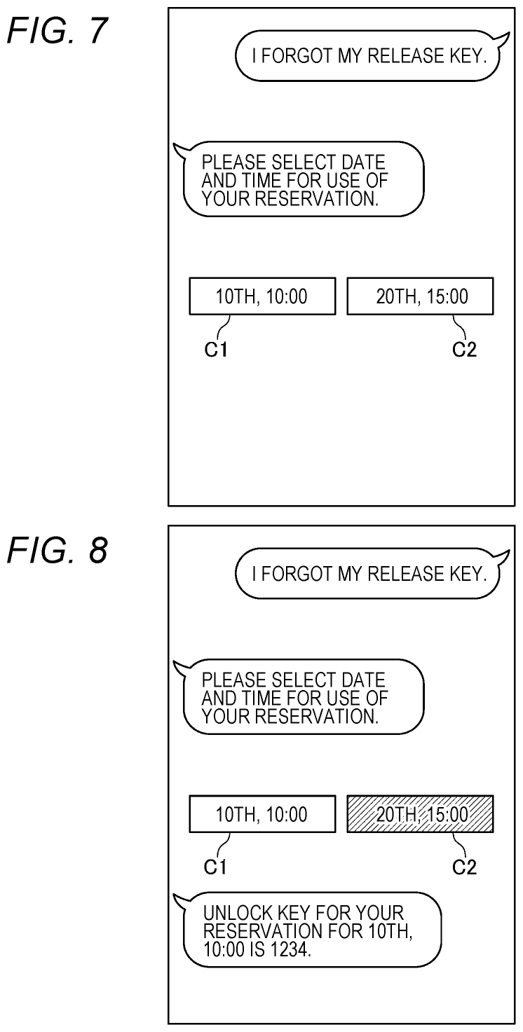

FIG. 7 is a diagram illustrating a state in which the user is being prompted to select one of the plurality of reserved rooms.

For example, as illustrated in FIG. 7, the user operates the touchscreen 41 and thereby can input “I forgot my unlock key,” and transmit the question to the management server 3. When the question receiving unit 312 receives such a question from the user and then it is determined that the user is not using the room 20, the situation acquisition unit 313 determines whether or not the number of reservations for rooms 20 made by the user associated with the question is two or more. When it is subsequently determined that the number of reservations is two or more, then the situation acquisition unit 313 displays a response: “Please select the date and time for use of your reservation,” as a report to the user, on the touchscreen 41 of the terminal device 4, and displays choices C1 and C2 that allow the user to select one of the plurality of reserved rooms 20 on the touchscreen 41 of the terminal device 4. In the example of FIG. 7, the choice C1 is a choice indicating a reservation for 10th, 10:00 and the choice C2 is a choice indicating a reservation for 20th, 15:00.

After the process of step ST11 is executed, or when it is determined in step ST10 that the number of reservations is not two or more (when it is determined that the number of reservations is one), the answer generation unit 314 generates an answer about the reserved room 20 in step ST12. The answer transmission unit 315 subsequently transmits the answer generated by the answer generation unit 314 to the terminal device 4, in step ST9 described above. The control means 31 subsequently ends the various processes.

FIG. 8 is a diagram illustrating a state after one of the plurality of reserved rooms is selected.

For example, as illustrated in FIG. 8, the user operates the touchscreen 41 and thereby can select the choice C1 from the choices C1 and C2 and transmit the selection result to the management server 3. In the embodiment, the choice C2, which has not been selected by the user, is grayed out.

The answer generation unit 314 then generates an answer about the room 20 related to the choice C1 selected by the user, and the answer transmission unit 315 transmits the answer about the room 20 related to the choice C1 to the terminal device 4. In the embodiment, the answer generation unit 314 generates an answer in such a manner as to display a response: “The unlock key for your reservation for 10th, 10:00 is 1234,” as a report to the user, on the touchscreen 41 of the terminal device 4.

Next, a procedure in a case where it is determined in step ST6 that the user has not reserved the room 20 is described.

When it is determined in step ST6 that the user has not reserved the room 20, the answer generation unit 314 generates a normal answer in step ST13. The answer transmission unit 315 subsequently transmits the answer generated by the answer generation unit 314 to the terminal device 4, in step ST9 described above. The control means 31 subsequently ends the various processes.

Here, the normal answer is an answer that enables responding appropriately to a human inquiry by causing AI to learn past questions and answers based on a technology such as deep learning, and is similar to a chatbot that uses the known AI technology.

According to such an embodiment, the following operations and effects can be achieved.
(1) The management server 3 notifies the user of the information on the target object via the terminal device 4 based on the target object information stored in the storage unit 32 when the situation acquisition unit 313 acquires the information that the position of the user is within the predetermined area. Therefore, the user can receive the information on the target object via the terminal device 4 by entering the predetermined area. Therefore, the target object management system 1 can notify the terminal device 4 of appropriate information on the target object in accordance with the situation of the user, and can improve user convenience.
(2) When receiving a user's question about a target object being an inquiry response target via the terminal device 4, the management server 3 causes the answer generation unit 314 to generate an answer about the user's question and causes the answer transmission unit 315 to transmit the answer generated by the answer generation unit 314, the answer being the information on the target object, to the terminal device 4. Therefore, the answer generation unit 314 can appropriately generate an answer to the user's question in accordance with the situation of the user, and the answer transmission unit 315 can notify the answer by transmitting the answer to the terminal device 4. Therefore, the target object management system 1 can transmit an appropriate answer to the user's question in accordance with the situation of the user to the terminal device 4, and can improve user convenience.
(3) The answer generation unit 314 changes the answer to the user's question based on the distance between the position of the user acquired by the user position acquisition unit and the position of the target object acquired by the target object position acquisition unit. Therefore, the target object management system 1 can transmit, to the terminal device 4, a more appropriate answer to the user's question in accordance with the situation of the user, and can improve user convenience.
(4) The user position acquisition unit acquires the position of the room 20 as the position of the user when the lock device 22 of the room 20 is unlocked properly. Therefore, it is possible to easily identify the position of the user without providing a new device or function to acquire the position of the user.
(5) The answer generation unit 314 generates an answer about the position of a mobile object acquired by the mobile object position acquisition unit 314A. Therefore, the user can easily grasp the position of the mobile object installed in the room 20.
(6) The management server 3 includes the device operating unit 314B that operates the devices 24 to 29 installed in the room 20, and the answer generation unit 314 generates answers about the devices 24 to 29 operated by the device operating unit 314B. Therefore, it is possible to appropriately answer questions about the operation of the devices 24 to 29 installed in the room 20 by actually operating the devices 24 to 29.
(7) The management server 3 includes the operating state acquisition unit 314C that acquires the operating states of the devices 24 to 29 installed in the room 20, and the answer generation unit 314 generates answers about the operating states of the devices 24 to 29 acquired by the operating state acquisition unit 314C. Therefore, it is possible to appropriately answer questions about malfunctions in the devices 24 to 29 installed in the room 20.

### ADDITIONAL IMPLEMENTATIONS

Note that the present disclosure is not limited to the above embodiment, and includes modifications and improvements that are made within the scope in which the object of the present disclosure can be achieved.

For example, in the above embodiment, the management server 3 may be configured of a server device of a centralized management type or of a distributed management type. For example, a server that uses a distributed ledger represented by a blockchain can be used.

In the above embodiment, the rooms 20 (hourly rental facilities) of the building 2 are exemplified as target objects. However, the target objects are not limited to, for example, conference rooms and training rooms, and may be, for example, tennis courts, baseball stadiums, athletic fields, and parking lots, which are outdoor spaces, and may be, for example, karaoke rooms, rental offices, reading spaces, rental cars, and rental bicycles, and are not limited to the above-mentioned hourly rental facilities, and may be articles, for example, furniture such as desks and chairs, multifunction machines, whiteboards, and liquid crystal displays, and may be services that use the Internet. Any kind of target object is acceptable as long as it has information. Under the circumstances, the target object management system may be configured in such a manner as to, when target objects with, for example, built-in electronic tags, like the air conditioner remote control 28 and the video remote control 29 in the embodiment, are taken to outside an hourly rental facility or outside a preset area, notify the information to, for example, the user, the manager, or the security service company to which the manager has outsourced the work, and furthermore may be configured in such a manner as to be capable of tracking the current location of the target object with the built-in electronic tag.

In the above embodiment, when it is determined in step ST6 that the user has not reserved the room 20, the answer generation unit 314 generates the normal answer in step ST13.

On the other hand, it may be configured in such a manner that the situation acquisition unit confirms whether or not there is a record of a reservation for the facility, based on the user associated with the question received by the question receiving unit and the reservation information stored in the storage unit, and when the situation acquisition unit confirms that there is the record of the reservation for the facility, the answer generation unit generates an answer about the facility having the record of the reservation.

According to such a configuration, when the situation acquisition unit confirms that there is the record of the reservation for the facility, the answer generation unit generates an answer about the facility having the record of the reservation. Therefore, it is possible to appropriately answer, for example, a question about the facility that the user used, after the date and time for use.

Moreover, the answer generation unit may be configured in such a manner as to generate an answer about an unlock key for unlocking a lock of the facility, as the answer about the facility having the record of the reservation.

According to such a configuration, the answer generation unit generates an answer about an unlock key for unlocking the lock of the facility, as the answer about the facility having the record of the reservation. Therefore, it is possible to generate an answer about an unlock key, for example, in a case of going back to the facility used by the user to get something that the user left behind, after the date and time for use. Therefore, the target object management system can transmit an appropriate answer to the user's question in accordance with the situation of the user to the information processing means, and can improve user convenience.

Moreover, the answer generation unit may be configured in such a manner as to grasp an available time slot(s) for the facility based on the reservation information stored in the storage unit, and generate an answer about an unlock key for unlocking the lock of the facility in the available time slot for the facility.

According to such a configuration, the answer generation unit grasps the available time slot(s) for the facility based on the reservation information stored in the storage unit, and generates an answer about an unlock key for unlocking the lock of the facility in the available time slot for the facility. Therefore, it is possible to prevent generation of an answer about an unlock key for unlocking the lock of the facility that is being used by another user.

Furthermore, the answer generation unit may be configured in such a manner as to cause the user to select at least one of the available time slots for the facility being a target for generating an answer about an unlock key.

According to such a configuration, the answer generation unit causes the user to select at least one of the available time slots for the facility being the target for generating the answer about the unlock key. Therefore, the user can select an available time slot for the facility being the target for generating an answer about an unlock key at his/her own convenience.

In the above embodiment, when it is determined in step ST7 that the user is using the room 20, the answer generation unit 314 generates an answer about the room 20 currently in use in step ST8.

On the other hand, the answer generation unit may be configured in such a manner as to, when the situation acquisition unit acquires information that the user is using the target object, as the situation of the user, generate an answer about an extension to the use time of the target object currently in use.

According to such a configuration, when the situation acquisition unit acquires the information that the user is using the target object, as the situation of the user, the answer generation unit generates an answer about the extension to the use time of the target object currently in use. Therefore, the user can inquire and confirm whether or not the use time of the target object currently in use can be extended.

Moreover, the answer generation unit may be configured in such a manner as to grasp an available time slot(s) for the target object based on the reservation information stored in the storage unit and to cause the user to select whether or not to extend the use time based on the available time slot(s) for the target object.

According to such a configuration, the answer generation unit grasps the available time slot(s) for the target object based on the reservation information stored in the storage unit, and causes the user to select whether or not to extend the use time based on the available time slot(s) for the target object. Therefore, the user can make an arrangement to extend the use time by selecting whether or not to extend the use time via the inquiry response management system.

In the above embodiment, when the situation acquisition unit 313 confirms that the user has reserved the room 20 and the situation acquisition unit 313 acquires the information that the user is using the room 20, as the situation of the user, the answer generation unit 314 generates an answer about the room 20 currently in use. On the other hand, it may be configured in such a manner that when the situation acquisition unit 313 acquires the information that the user is using the room 20, as the situation of the user, without confirming that the user has reserved the room 20, the answer generation unit 314 generates an answer about the room 20 currently in use, and the answer transmission unit 315 transmits the answer to the terminal device 4. In short, the management server is simply required to be capable of notifying the user of information on the target object via the information processing means based on the target object information stored in the storage unit when the situation acquisition unit acquires information that the position of the user is within the predetermined area. For example, the management server may be configured in such a manner as to, when the situation acquisition unit acquires the information that the position of the user is within a predetermined area such as a store that sells goods, notify the user of information on an introduction to the store and descriptions of the goods via the information processing means, or to attend to the user by notifying the user of the information.

In the above embodiment, it is configured in such a manner that questions and responses are inputted and outputted in characters, but it may be configured in such a manner that questions and responses are inputted and outputted by use of another method. For example, it may be configured in such a manner as to input and output voice to ask and answer a question, or may be configured in such a manner as to ask a question by directing the user's eyes at a target object by use of, for example, smart glasses.

Note that the management server of the present disclosure may include: a command receiving unit that receives a user's command via the information processing means; and an operation execution unit that executes an operation in response to the user's command when the command receiving unit receives the user's command.

According to such a configuration, if the command receiving unit receives the user's command, the management server causes the operation execution unit to execute an operation in response to the user's command. Therefore, the user can cause the management server to execute a desired operation by transmitting a command to the management server.

Moreover, in this case, the operation execution unit may be configured in such a manner as to cause the target object to execute a predetermined operation based on the user's command received by the command receiving unit.

According to such a configuration, the operation execution unit causes the target object to execute the predetermined operation based on the user's command received by the command receiving unit. Therefore, for example, when the user looks for a target object (the air conditioner remote control 28 or the video remote control 29) in a predetermined area (the room 20), the user can transmit a command to cause the target object to produce a sound and confirm the position of the target object. Therefore, the management server can improve user convenience.

The foregoing description has been described with reference to specific implementations. However, the illustrative discussions above are not intended to be exhaustive or to limit the claims to the precise forms disclosed. Many variations are possible in view of the above teachings. The implementations were chosen and described to best explain principles of operation and practical applications, to thereby enable others skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

As used herein: the singular forms “a”, “an,” and “the” include the plural forms as well, unless the context clearly indicates otherwise; the term “and/or” encompasses all possible combinations of one or more of the associated listed items; the terms “first,” “second,” etc. are only used to distinguish one element from another and do not limit the elements themselves; the term “if” may be construed to mean “when,” “upon,” “in response to,” or “in accordance with,” depending on the context; and the terms “include,” “including,” “comprise,” and “comprising” specify particular features or operations but do not preclude additional features or operations.

What is claimed is:

1. A target object management system comprising:
a management server configured to manage a target object; and
an information processing means connected to the management server via a communication line and configured to process information and output the information to a user of the target object, wherein
the management server includes:
a storage unit configured to store target object information on the target object;
a user position acquisition unit configured to acquire a position of the user; and
a situation acquisition unit configured to acquire information on whether or not the position of the user acquired by the user position acquisition unit is within a predetermined area, as a situation of the user, and
upon the situation acquisition unit acquiring information that the position of the user is within the predetermined area, the management server notifies the user of information on the target object via the information processing means, based on the target object information stored in the storage unit.

2. The target object management system according to claim 1, wherein
the management server includes:
a question receiving unit configured to receive a user's question about the target object being an inquiry response target via the information processing means;
an answer generation unit configured to, upon the question receiving unit receiving the user's question, generate an answer to the user's question; and
an answer transmission unit configured to transmit the answer generated by the answer generation unit to the information processing means.

3. The target object management system according to claim 2, wherein
the management server includes a target object position acquisition unit configured to, upon the question receiving unit receiving the user's question, acquire a position of the target object associated with the question received by the question receiving unit, and
the answer generation unit changes the answer to the user's question based on a distance between the position of the user acquired by the user position acquisition unit and the position of the target object acquired by the target object position acquisition unit.

4. The target object management system according to claim 2, wherein
the answer generation unit acquires related information related to the target object associated with the user's question received by the question receiving unit from outside of the management server via the communication line, and generates an answer to the user's question based on the related information.

5. The target object management system according to claim 1, wherein the management server includes:
a command receiving unit configured to receive a user's command via the information processing means; and
an operation execution unit configured to, upon the command receiving unit receiving the user's command, execute an operation in response to the user's command.

6. The target object management system according to claim 5, wherein the operation execution unit causes the target object to execute a predetermined operation based on the user's command received by the command receiving unit.

7. The target object management system according to claim 1, further comprising:
a facility as a target object connected to the management server and the information processing means via the communication line, wherein
the facility includes a lock device that locks and unlocks the facility, and
the user position acquisition unit acquires a position of the facility as the position of the user upon the lock device of the facility being unlocked properly.

8. The target object management system according to claim 7, wherein
the management server includes a mobile object position acquisition unit configured to acquire a position of a mobile object as a target object installed in the facility, and
the answer generation unit generates an answer about the position of the mobile object acquired by the mobile object position acquisition unit.

9. The target object management system according to claim 7, wherein
the management server includes a device operating unit configured to operate a device as a target object installed in the facility, and
the answer generation unit generates an answer about the device operated by the device operating unit.

10. The target object management system according to claim 7, wherein
the management server includes an operating state acquisition unit configured to acquire an operating state of a device as a target object installed in the facility, and
the answer generation unit generates an answer about the operating state of the device acquired by the operating state acquisition unit.
